(19) United States
(12) Patent Application Publication
(10) Pub. No.: US 2024/0304019 A1
(43) Pub. Date: Sep. 12, 2024

(54) METHOD FOR COMPARING DOCUMENTS AND SYSTEM THEREFOR

(71) Applicant: SAMSUNG SDS CO, LTD., Seoul (KR)

(72) Inventors: Sun Jin KIM, Seoul (KR); NARESH REDDY YARRAM, Seoul (KR); DO YOUNG PARK, Seoul (KR); Min KYU KIM, Seoul (KR)

(73) Assignee: SAMSUNG SDS CO, LTD., Seoul (KR)

(21) Appl. No.: 18/597,390

(22) Filed: Mar. 6, 2024

(30) Foreign Application Priority Data
Mar. 8, 2023 (KR) 10-2023-0030368
Oct. 31, 2023 (KR) 10-2023-0147322

(51) Int. Cl. G06V 30/418; G06V 10/44; G06V 10/771

(52) U.S. Cl. CPC G06V 30/418; G06V 10/44; G06V 10/771

(57) ABSTRACT

A method for comparing documents and a system therefor are provided. The method according to some embodiments may include acquiring a first document image and a second document image, extracting a first feature set from the first document image and a second feature set from the second document image through an encoder, generating a correlation feature set by analyzing a correlation between at least part of the first feature set and at least part of the second feature set, and outputting a result of comparison between the first document image and the second document image based on a result of decoding the correlation feature set.

### CROSS-REFERENCE TO RELATED APPLICATION(S)

This application claims priority from Korean Patent Application No. 10-2023-0030368, filed on Mar. 8, 2023, and Korean Patent Application No. 10-2023-0147322, filed on Oct. 31, 2023, in the Korean Intellectual Property Office, and all the benefits accruing therefrom under 35 U.S.C. 119, the contents of which in its entirety are herein incorporated by reference(s).

### BACKGROUND

### 1. Field

The present disclosure relates to a method for comparing documents and a system therefor, and more particularly, to a method for comparing two documents and detecting differences through deep learning technology and a system therefor.

### 2. Description of the Related Art

Document comparison technology may be widely utilized in various fields. For example, the document comparison technology may be used to detect major changes in contracts. As another example, the document comparison technology may be employed to check for updates between different versions of documents.

A conventional document comparison technique primarily compares the contents of documents based on text. For example, when scan images of documents are provided, the conventional document comparison technique extracts texts from the scan images using optical character recognition (OCR) and compares the extracted texts.

However, the conventional document comparison technique has various limitations. The conventional document comparison technique includes problems related to OCR accuracy due to the quality of scan images (e.g., frequent misrecognition of characters in low-quality scan images with noise or skew), and difficulties in applying OCR to multi-lingual document images. For example, to apply OCR to multi-lingual document images, suitable OCR models for each language included in the document images are required. However, building OCR models with high accuracy for each language demands considerable time, financial resources, and human resources (e.g., costs for labeling, etc.).

### SUMMARY

Aspects of the present disclosure provide a method and system capable of accurately detecting differences (e.g., changes) by comparing the contents of given documents.

Aspects of the present disclosure also provide a method and system that may accurately compare the contents of documents, regardless of the languages included in the documents (or language-independently).

Aspects of the present disclosure also provide a document comparison method that is robust against differences in font, quality, etc. in document images.

Aspects of the present disclosure also provide the structure and learning (training) method of a deep learning model that may accurately compare the contents of documents.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for comparing documents performed by at least one processor. The method may include acquiring a first document image and a second document image, extracting a first feature set from the first document image and a second feature set from the second document image through an encoder, generating a correlation feature set by analyzing a correlation between at least part of the first feature set and at least part of the second feature set, and outputting a result of comparison between the first document image and the second document image based on a result of decoding the correlation feature set.

In some embodiments, the first feature set may include a first feature and a second feature of a different scale from the first feature, and the second feature set may include a third feature of a same scale as the first feature and a fourth feature of a same scale as the second feature, and the generating the correlation feature set may include generating a first correlation feature, which belongs to the correlation feature set, by analyzing a correlation between the first feature and the third feature, and generating a second correlation feature, which belongs to the correlation feature set, by analyzing a correlation between the second feature and the fourth feature.

In some embodiments, the generating the correlation feature set may include generating a first attention feature and a second attention feature by performing an attention operation on a first feature, which belong to the first feature set, and a second feature, which belong to the second feature set and generating one or more correlation features that belong to the correlation feature set by performing a correlation operation on the first attention feature and the second attention feature.

In some embodiments, the generating the first attention feature and the second attention feature may include performing a first attention operation on the first feature and the second feature, and generating the first attention feature by performing a second attention operation on the first feature and a result of the first attention operation.

In some embodiments, the first feature corresponds to a query, and the second feature corresponds to a key for the first attention operation, and the generating the first attention feature and the second attention feature may further include performing a third attention operation on the first feature and the second feature, wherein the second feature corresponds to a query for the third attention operation and the first feature corresponds to a key for the third attention operation, and generating the second attention feature by performing a fourth attention operation on the second feature and a result of the third attention operation.

In some embodiments, the first attention feature and the second attention feature are feature maps including a plurality of pixels, respectively, and the generating the one or more correlation features may include determining a first pixel region in the second attention feature that corresponds to a first pixel in the first attention feature, wherein the first pixel region includes a second pixel in the second attention feature that exists at a location corresponding to the first pixel and a neighboring pixel of the second pixel, and generating a first correlation feature by performing a correlation operation on the first pixel and pixels included in the first pixel region.

In some embodiments, the first correlation feature is a feature map including a plurality of pixels, and the generating the first correlation feature may include calculating vector similarities between a channel vector for the first pixel and channel vectors for the pixels included in the first pixel region, and the calculated vector similarities form a channel vector for a third pixel in the first correlation feature that corresponds to the first pixel.

In some embodiments, the generating the one or more correlation features may further include determining a second pixel region in the first attention feature that corresponds to a third pixel in the second attention feature, wherein the second pixel region includes a fourth pixel in the first attention feature that exists at a location corresponding to the third pixel and a neighboring pixel of the fourth pixel, and generating a second correlation feature by performing a correlation operation on the third pixel and pixels included in the second pixel region.

In some embodiments, the first feature set may include multi-scale features, a first feature of a largest scale among the multi-scale features is excluded from the analyzing the correlation, and the outputting the result of comparison may include outputting the result of comparison based on a result of decoding of the correlation feature set and the first feature.

In some embodiments, the outputting the result of comparison may further include performing a first attention operation on the first feature and a first correlation feature that belongs to the correlation feature set, performing a second attention operation on the first correlation feature and a result of the first attention operation, and performing decoding based on a result of the second attention operation.

In some embodiments, the outputting the result of comparison may include generating a segmentation map for the first document image by decoding at least part of the correlation feature set through a first decoder, wherein the segmentation map indicates information on areas in the first document image that are identical to and different from the second document image.

In some embodiments, the method may further include calculating a loss between the generated segmentation map and a ground truth segmentation map, and updating parameters of the encoder and the first decoder based on the calculated loss, wherein the loss is calculated using a dice loss function and a cross-entropy loss function.

In some embodiments, the method may further include acquiring a result of prediction of whether the first document image is identical to the second document image by inputting the generated segmentation map to a classifier, and updating parameters of the encoder and the first decoder based on a loss between the result of prediction and a ground truth.

In some embodiments, the correlation feature set may include a first correlation feature, which is generated based on a feature from the first feature set, and a second correlation feature, which is generated based on a feature from the second feature set, and the outputting the result of comparison may include generating a first segmentation map for the first document image, which indicates information on areas in the first document image that are identical to and different from the second document image, by decoding the first correlation feature through a first decoder, and generating a second segmentation map for the second document image, which indicates information on areas in the second document image that are identical to and different from the first document image, by decoding the second correlation feature through a second decoder.

In some embodiments, the method may further include calculating a first loss between the first segmentation map and a first ground truth segmentation map for the first document image, calculating a second loss between the second segmentation map and a second ground truth segmentation map for the second document image, and updating parameters at least one of the encoder, the first decoder, and the second decoder based on the first loss and the second loss.

According to another aspect of the present disclosure, there is provided a system for comparing documents. The system may include at least one processor, and a memory configured to store a computer program that is executed by the at least one processor, wherein the computer program includes instructions to perform: acquiring a first document image and a second document image, extracting a first feature set from the first document image and a second feature set from the second document image through an encoder, generating a correlation feature set by analyzing a correlation between at least part of the first feature set and at least part of the second feature set, and outputting a result of comparison between the first document image and the second document image based on a result of decoding the correlation feature set.

According to yet another aspect of the present disclosure, there is provided a non-transitory computer-readable recording medium storing a computer program, which, when executed by at least one processor, causes the at least one processor to perform acquiring a first document image and a second document image, extracting a first feature set from the first document image and a second feature set from the second document image through an encoder, generating a correlation feature set by analyzing a correlation between at least part of the first feature set and at least part of the second feature set, and outputting a result of comparison between the first document image and the second document image based on a result of decoding the correlation feature set.

### BRIEF DESCRIPTION OF THE DRAWINGS

The above and other aspects and features of the present disclosure will become more apparent by describing in detail example embodiments thereof with reference to the attached drawings, in which:

FIG. 1 is a schematic drawing for explaining the operation of a document comparison system according to some embodiments of the present disclosure;

FIG. 2 is a schematic diagram illustrating the input and output of a deep learning model according to some embodiments of the present disclosure;

FIG. 3 is a schematic diagram for explaining the structure and operation of the deep learning model according to some embodiments of the present disclosure;

FIG. 4 is a schematic diagram for explaining the structure and operation of a deep learning model using multi-scale features according to some embodiments of the present disclosure;

FIG. 5 is a schematic diagram for explaining the structure and operation of a correlation analyzer according to some embodiments of the present disclosure;

FIG. 6 is a schematic diagram for explaining the structure and operation of a first attention operator according to some embodiments of the present disclosure;

FIGS. 7 through 9 are schematic diagrams for explaining the structure and operation of the correlation analyzer according to some embodiments of the present disclosure;

FIG. 10 is a schematic drawing for explaining the structure and operation of a first decoder according to some embodiments of the present disclosure;

FIG. 11 is a schematic drawing for explaining the structure and operation of a second attention operator according to some embodiments of the present disclosure;

FIGS. 12 and 13 are schematic diagrams illustrating actual implementations of the deep learning model according to some embodiments of the present disclosure;

FIG. 14 is a flowchart illustrating a document comparison method according to some embodiments of the present disclosure;

FIG. 15 is a detailed flowchart illustrating the generation of a correlation feature set, as performed in the document comparison method of FIG. 14;

FIG. 16 is a detailed flowchart illustrating the generation of an attention feature, as performed in the document comparison method of FIG. 14;

FIG. 17 is a detailed flowchart illustrating the outputting of comparison results for first and second documents, as performed in the document comparison method of FIG. 14;

FIGS. 18 and 19 are schematic diagrams for explaining the training procedure of the deep learning model according to some embodiments of the present disclosure;

FIG. 20 shows experimental results for the performance of the document comparison method according to some embodiments of the present disclosure; and

FIG. 21 is a hardware configuration view illustrating an example computing device that may implement the document comparison system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Various embodiments of the present disclosure will hereinafter be described in detail with reference to the accompanying drawings.

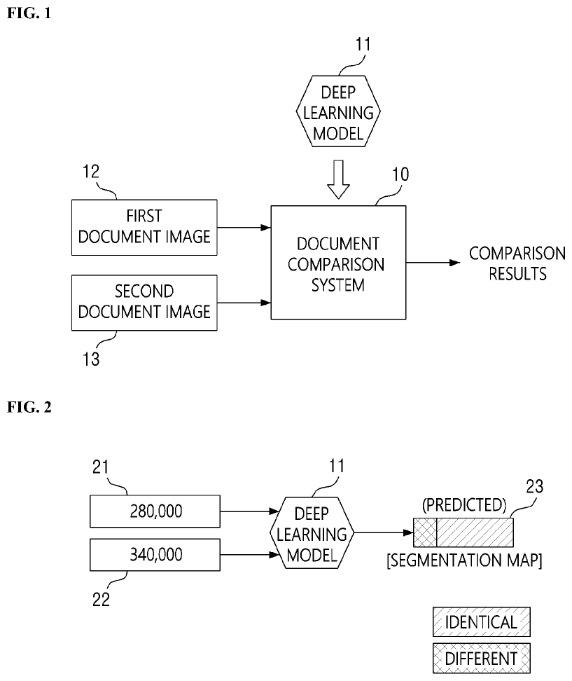

FIG. 1 is a schematic drawing for explaining the operation of a document comparison system 10 according to some embodiments of the present disclosure.

Referring to FIG. 1, the document comparison system 10 is a computing device/system that compares first and second documents and output the results of the comparison (e.g., whether the first and second documents are identical, parts where the first and second documents are different, the rate of similarity (or match rate) between the first and second documents, etc.). For example, the document comparison system 10 may compare the first and second documents at an image level, i.e., compare first and second document images 12 and 13, through a deep learning model 11. In this manner, the time and computing cost required for training in various languages may be reduced because image-level document comparison, unlike optical character recognition (OCR)-based document comparison, does not require language-specific training, and document comparison may be performed regardless of the languages included in given documents (or language-independently). Accordingly, multilingual documents may also be easily compared. For convenience, the document comparison system 10 will hereinafter be referred to simply as the comparison system 10.

The first document (or the second document) may also be referred to as a source document or a comparison reference document, and the second document (or the first document) may also be referred to as a target document, a comparison target document, etc.

The deep learning model 11 is a model used for document comparison and is a model that performs document comparison at the image level. That is, the deep learning model 11 may be configured and trained to receive the first and second document images 12 and 13 as inputs and output comparison results for the two document images.

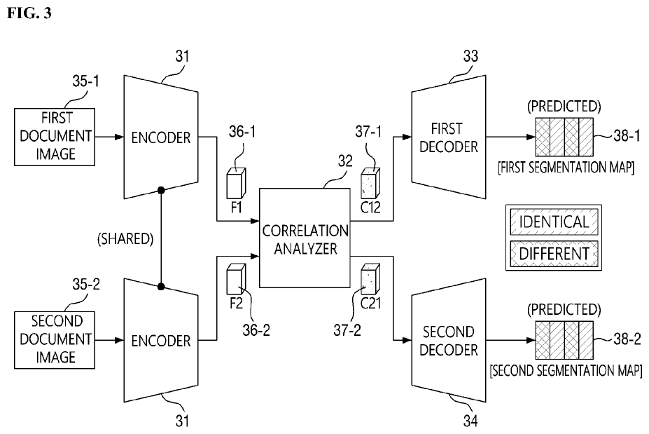

For example, as illustrated in FIG. 2, the deep learning model 11 may receive a first document image 21 and a second document image 22 as inputs and output a segmentation map 23 for the first document image 21 and/or the second document image 22. The segmentation map 23 represents a map that indicates information on areas where the first and second document images 21 and 22 are identical or match and areas where they are different (or do not match) (e.g., a map where the matching areas and the non-matching areas are defined as separate classes, and class prediction values are assigned to each pixel). A semantic segmentation task and a segmentation map that results from the semantic segmentation task are already well known in the art to which the present disclosure pertains, and thus, detailed descriptions thereof will be omitted. The segmentation map 23 may also be referred to as a segmentation mask, a segmentation label, etc.

FIG. 2 illustrates an example where the deep learning model 11 outputs a single segmentation map 23 for either the first document image 21 or the second document image 22, but the present disclosure is not limited thereto.

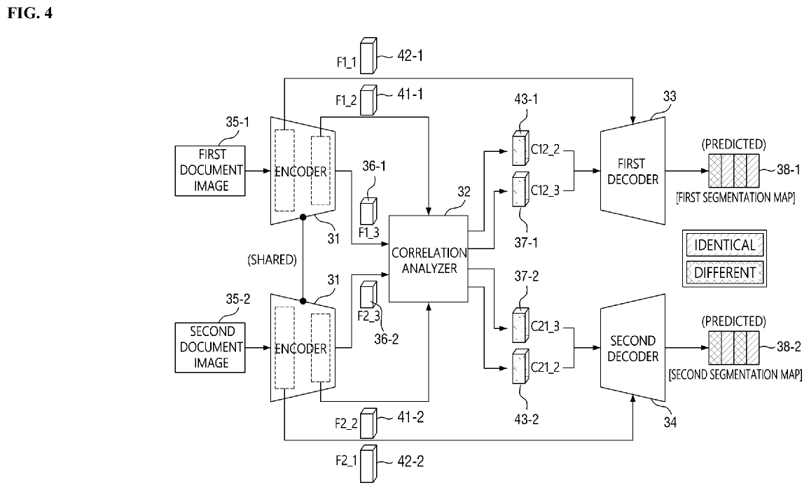

The structure, training method, etc., of the deep learning model 11 will be described later with reference to FIG. 3 and the subsequent drawings.

The comparison system 10 may be implemented with at least one computing device. For example, all functions of the comparison system 10 may be implemented on a single computing device. Alternatively, first and second functionalities of the comparison system 10 may be implemented on first and second computing devices, respectively. Yet alternatively, a particular functionality of the comparison system 10 may be implemented on multiple computing devices.

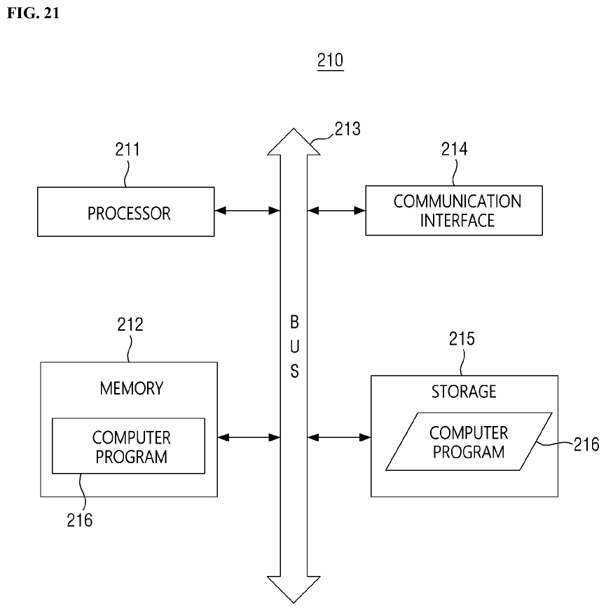

Here, the term “computing device” may encompass nearly any device equipped with computing capabilities, and an example computing device will be described later with reference to FIG. 21. As a computing device is an assembly where various components (e.g., memories, processors, etc.) interact, it may also be referred to as a computing system, which obviously, may also include the concept of an assembly where multiple computing devices interact.

The operation of the comparison system 10 has been briefly described so far with reference to FIGS. 1 and 2. The structure and operation of an example deep learning model 11 will hereinafter be described with reference to FIG. 3 and the subsequent drawings.

FIG. 3 is a schematic drawing illustrating the structure and operation of the deep learning model 11. Referring to FIG. 3 and the subsequent drawings, each feature symbol, for example, “F1_1”, consists of a combination of an alphabet letter (e.g., “F”, “A”, and “C”) indicating the type of feature, a number indicating which document image the corresponding feature is associated with (e.g., “1” for association with a first document image, “2” for association with a second document image, and “12” for association with both the document images, but indicating that document comparison has been performed based more on the first document image than on the second document image), an underscore “_”, and a number indicating the scale of the corresponding feature (e.g., “1” for a largest scale and “3” for a smallest scale).

As illustrated in FIG. 3, the deep learning model 11 may include an encoder 31, a correlation analyzer 32, and one or more decoders, i.e., first and second decoders 33 and 34. FIG. 3 illustrates an example where the deep learning model 11 has two independent decoders to two output comparison results (38-1 and 38-2) respectively corresponding to two document images (35-1 and 35-2), but the present disclosure is not limited thereto. Alternatively, the deep learning model 11 may be configured to have only one decoder. For convenience, however, the deep learning model 11 will hereinafter be described as including two decoders, i.e., the first and second decoders 33 and 34, as illustrated in FIG. 3.

The encoder 31 is a common module that extracts features (or feature sets) from input document images, for example, the first document image 35-1. For example, the encoder 31 may be used to extract a feature 36-1 from the first document image 35-1 and may also be used to extract a feature 36-2 from the second document image 35-2.

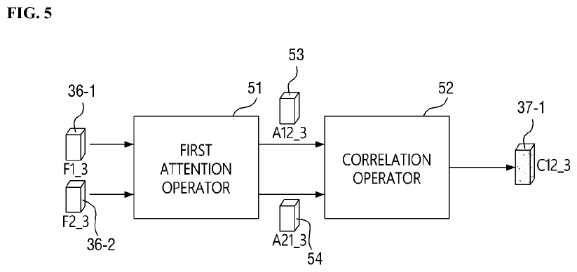

The encoder 31 may be implemented based on, for example, a convolutional neural network (CNN). For example, the encoder 31 may be configured to include multiple convolutional layers to extract multi-scale features from the input document images (see FIG. 4).

In some embodiments, multi-scale features may be extracted by the encoder 31. For example, as illustrated in FIG. 4, a largest scale feature (or a feature at the lowest level of abstraction), for example, a feature 43-3 may be extracted in a first layer (e.g., a convolutional layer) of the encoder 31, an intermediate scale feature (or a feature at an intermediate level of abstraction), for example, a multi-scale feature 41-1, may be extracted in a second layer of the encoder 31 at the rear of the first layer, and a smallest scale feature (or a feature at a highest level of abstraction), for example, a multi-scale feature 36-1, may be extracted in a third layer (or the last or rearmost layer) of the encoder 31. However, the present disclosure is not limited to this example, and the number of features extracted may vary. The deep learning model 11 may extract features 36-1, 41-1, and 42-1 for the first document image 35-1 and features 36-2, 41-2, and 42-2 for the second document image 35-2. In this case, the features 36-1, 41-1, and 42-1 may have the same scale as the features 36-2, 41-2, and 42-2, respectively. By performing document comparison using multi-scale features, the accuracy of comparison between document images that include characters of various sizes may be enhanced.

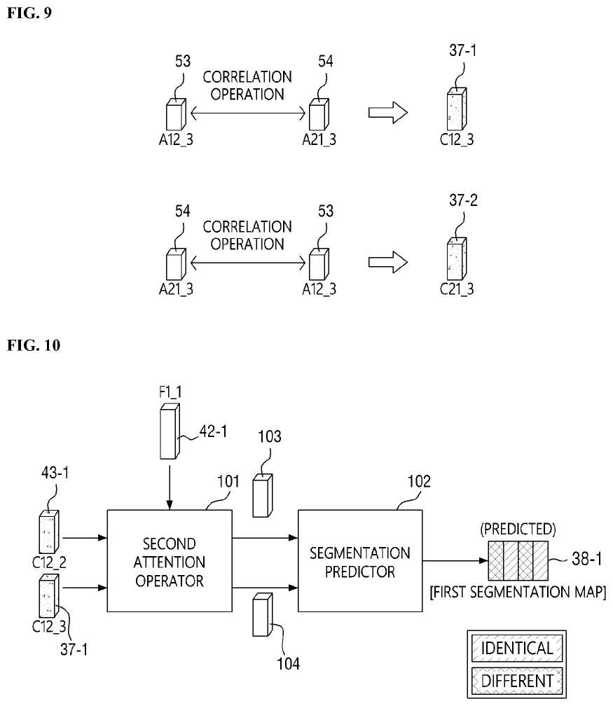

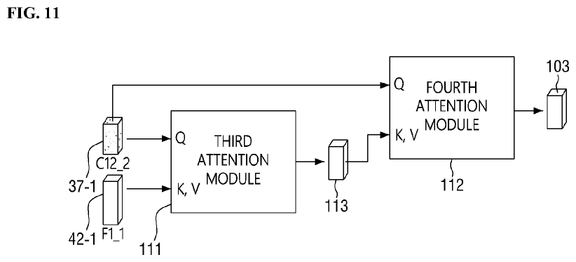

In some embodiments, as illustrated in FIG. 4, a skip-connection may be formed so that a largest scale feature containing a largest amount of information, among the extracted multi-scale features, is input to each decoder. For example, the feature 42-1, among the features 36-1, 41-1, and 42-1, may be input to the first decoder 33, and the feature 42-2, among the features 36-2, 41-2, and 42-2, may be input to the second decoder 34. In this case, the first decoder 33 may easily generate a sophisticated segmentation map 38-1 by performing decoding using the richer information contained in the feature 42-1. This decoding process will be described later in further detail with reference to FIGS. 10 and 11.

The multi-scale features (or feature sets) will hereinafter be described as being extracted by the encoder 31 of the deep learning model 11.

Referring back to FIG. 3 or 4, the correlation analyzer 32 is a module that analyzes the correlation between input features, i.e., the features 36-1 and 36-2. In other words, the correlation analyzer 32 may generate one or more correlation features (or sets of correlation features), i.e., correlation features 37-1 and 43-1, by analyzing feature-level correlations. Here, the correlation features may represent features containing correlation information, and correlation analysis may be understood as a process of comparing document images at a feature level. Comparing document images at the feature level may minimize the influence of font and quality differences on the accuracy of document comparison, as font differences, quality differences (e.g., differences in document tilt), etc., are less pronounced at the feature level.

Correlation may also be referred to as association, relatedness, similarity, etc.

If multi-scale features are extracted by the encoder 31, the correlation analyzer 32 may generate correlation features for each scale. For example, the correlation analyzer 32 may analyze the correlation between features of a first scale, i.e., the features 36-1 and 36-2, to generate a first-scale correlation feature, i.e., the correlation feature 37-1, and analyze the correlation between features of a second scale, i.e., the features 41-1 and 41-2, to generate a second-scale correlation feature, i.e., the correlation feature 43-1.

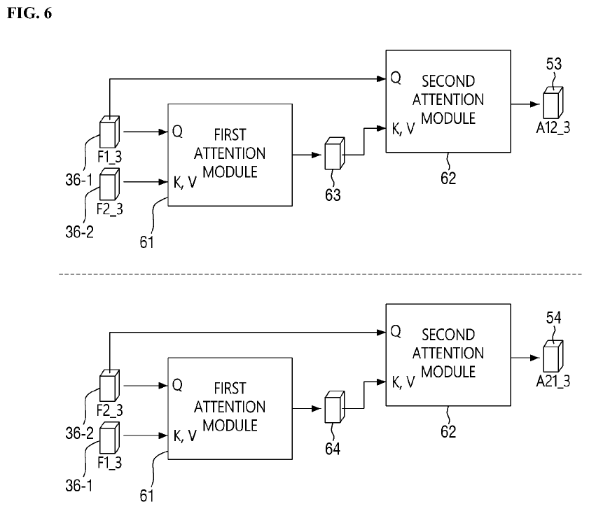

In some embodiments, as illustrated in FIG. 5, the correlation analyzer 32 may be configured to include a first attention operator 51 and a correlation operator 52, and this will hereinafter be described with reference to FIGS. 5 through 9.

FIG. 5 is a schematic drawing for explaining the structure and operation of the correlation analyzer 32. FIG. 5 illustrates an example where the correlation feature 37-1 is generated from the smallest scale features 36-1 and 36-2, and correlation features may also be generated for other scales (e.g., the scale of the features 41-1 and 41-2) in a manner that will be described later. For convenience, the feature 36-1 and an attention feature 53 associated with the first document image 35-1 will hereinafter be referred to as the first feature 36-1 and the first attention feature 53, respectively, and the feature 36-2 and an attention feature 54 associated with the second document image 35-2 will hereinafter be referred to as the second feature 36-2 and the second attention feature 54, respectively.

As illustrated in FIG. 5, the correlation analyzer 32 may be configured to include the first attention operator 51 and the correlation operator 52.

The first attention operator 51 is a module that performs an attention operation (i.e., cross-attention operation) on the first and second features 36-1 and 36-2. Here, the attention operation may be an operation based on a query, a key, and a value, as exemplified by Equation 1 below. In Equation 1, Q, K, and V represent a query, a key, and a value, respectively, and de represents the dimensionality of a key vector. The attention operation according to Equation 1 and how to derive the query Q, the key K, and the value V for the attention operation (e.g., by applying corresponding weight matrices to input data) are already well known in the art to which the present disclosure pertains, and thus, detailed descriptions thereof will be omitted.

$$Attention ( Q , K , V ) = softmax ( \frac{{QK}^{T}}{\sqrt{{d}_{k}}} ) V \qquad < Equation 1 >$$

The first attention operator 51 may perform an attention operation on the first and second features 36-1 and 36-2, thereby generating the first and second attention features 53 and 54. Specifically, the first attention operator 51 may correspond the first feature 36-1 with a query (i.e., generate query vectors from the first feature 36-1) and the second feature 36-2 with a key and a value, and then perform an attention operation, thereby generating the first attention feature 53. Here, the term “attention feature” refers to a feature that reflects the result of an attention operation. Additionally, the first attention operator 51 may correspond the second feature 36-2 with the query Q and the first feature 36-1 with the key K and the value V, and then perform the same attention operation again, but in the opposite direction, thereby generating the second attention feature 54. In this case, the first attention feature 53 may be considered more associated with the first document image 35-1 because it is based on the first feature 36-1. Similarly, the second attention feature 54 may be considered more associated with the second document image 35-2.

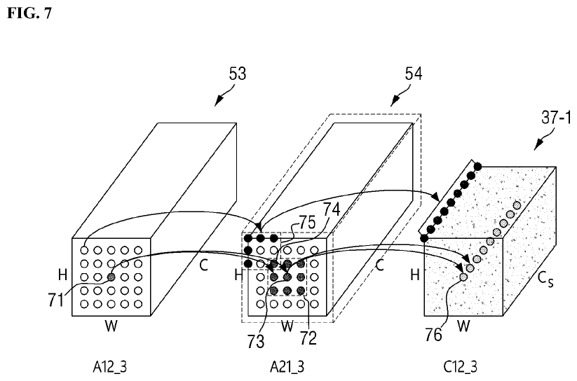

In some embodiments, as illustrated in FIG. 6, the first attention operator 51 may be configured to include a first attention module 61 and a second attention module 62. That is, the first attention operator 51 may be configured to consecutively perform two attention operations. However, the present disclosure is not limited to this. Alternatively, the first attention operator 51 may be configured to consecutively perform three or more consecutive attention operations. Specifically, the first attention module 61 of the first attention operator 51 may perform the first attention operation (or 1-th/primary attention operation) on the first feature 36-1, thereby obtaining the first attention operation result 63. In this first attention operation for obtaining the first attention operation result 63, the first feature 36-1 corresponds to a query Q, and the second feature 36-2 corresponds to a key K and a value V. Then, the second attention module 62 of the first attention operator 51 may perform the second attention operation (or 2-th/secondary attention operation) on the first feature 36-1 and the first attention operation result 63, as indicated by reference numeral 62, thereby generating the first attention feature 53. Additionally, the first attention operator 51 may consecutively perform attention operations in the opposite direction, thereby generating the second attention feature 54. Specifically, the first attention module 61 of the first attention operator 51 may perform the first attention operation on the second feature 36-2 and the first feature 36-1, thereby obtaining the first attention operation result 64. In this first attention operation for obtaining the first attention operation result 64, the second feature 36-2 corresponds to the query Q, and the first feature 36-1 corresponds to the key K and the value V for the first attention operation. Then, the second attention module 62 of the first attention operator 51 may perform the second attention operation on the second feature 36-2 and the first attention operation result 64, thereby generating the second attention feature 54.

Referring back to FIG. 5, the correlation operator 52 is a module that performs a correlation operation on input attention features (53 and 54). As illustrated, the input attention features (53 and 54) may include the first attention feature 53, associated with the first document image 35-1, and the second attention feature 54, associated with the second document image 35-2.

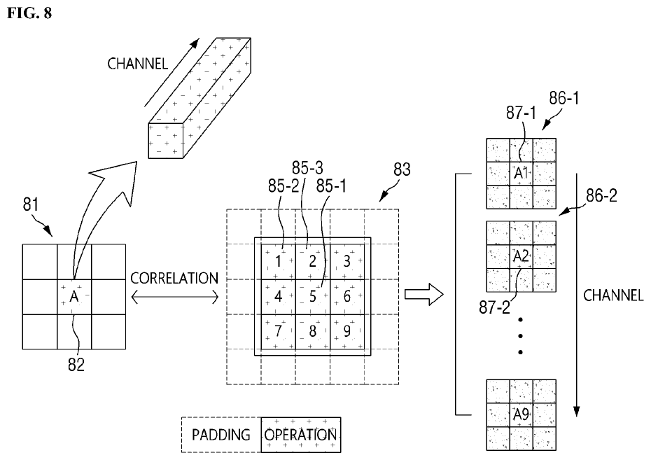

A correlation operation may be performed, for example, by calculating the similarities (i.e., vector similarities) between the channel vectors that form the first attention feature 53 and the channel vectors that form the second attention feature 54. An example correlation operation (i.e., the operation of the correlation operator 52) will hereinafter be described with reference to FIGS. 7 and 8.

FIGS. 7 and 8 are schematic drawings for explaining the operation of the correlation operator 52.

Referring to FIG. 7, it is assumed that the first and second attention features 53 and 54 are configured as three-dimensional (3D) feature maps. In other words, each pixel (e.g., a pixel 71) in a two-dimensional (2D) feature map (i.e., an H-W feature map) represents a channel vector.

In this case, the correlation operator 52 may calculate a vector similarity (e.g., cosine similarity) between the pixel 71 of the first attention feature 53 and a pixel region 72 of the second attention feature 54. The pixel region 72 may include a pixel 73 of the second attention feature 54 that corresponds to the pixel 71 and neighboring pixels 74 around the pixel 73.

A padding technique may be applied to the second attention feature 54, so that all the pixels in the first attention feature 53 correspond to respective pixel regions of the second attention feature 54, as indicated by dashed lines. Nearly any type of padding technique may be used.

The correlation operator 52 may generate channel vectors (e.g., a channel vector 76) that form the correlation feature 37-1 based on the vector similarities between an individual pixel (e.g., the pixel 71) of the first attention feature 53 and the corresponding pixel region (e.g., the pixel region 73) of the second attention feature 54. For example, the value of the channel vector 76 may be the similarity between the channel vector for the pixel 71 and the channel vector for a pixel 74. Furthermore, the correlation operator 52 may repeat this process for other pixels of the first attention feature 53, thereby generating the correlation feature 37-1.

For a better understanding, a detailed explanation of the operation of the correlation operator 52 will be provided with reference to FIG. 8. FIG. 8 illustrates an example where the padding technique is applied to a second feature map 83. Referring to FIG. 8, a first feature map 81 and the second feature map 83 may be understood as corresponding to the first attention feature 53 and the second attention feature 54, respectively.

Referring to FIG. 8, it is assumed that a correlation operation is performed between a center pixel 82 (see “A”) of the first feature map 81 and a pixel region (or pixel area) 84 of the second feature map 83. As previously mentioned, the pixel region 84 may include a pixel 85-1 of the second feature map 83 that corresponds to the center pixel 82 and neighboring pixels (e.g., pixels 85-2 and 85-3) around the pixel 85-1. Here, the size of the pixel region 84 (e.g., the number of neighboring pixels) may be a hyperparameter set in advance, but the present disclosure is not limited thereto.

In this case, the correlation operator 52 may determine the value of a pixel 87-1 of a feature map 86-1 of a first channel of a correlation feature based on the vector similarity between the center pixel 82 and a first neighboring pixel 85-2 of the pixel region 84. For example, pixel “A1” may be a pixel to which the result of a correlation operation performed on pixel “A” and pixel “1” (see the first neighboring pixel 85-2) is assigned. As mentioned earlier, the vector similarity between the center pixel 82 and the first neighboring pixel 85-2 implies the similarity between the channel vectors for the center pixel 82 and the first neighboring pixel 85-2.

Moreover, the correlation operator 52 may determine the value of a pixel 87-2 of a feature map 86-2 of a second channel of the correlation feature based on the vector similarity between the center pixel 82 and a second neighboring pixel 85-3 of the pixel region 84. By repeating this process for other pixels of the pixel region 84, channel vectors containing correlation information between the center pixel 82 and the pixel region 84 (i.e., channel vectors with the values of the pixels 87-1 and 87-2 as their elements) may be generated.

Meanwhile, in some embodiments, the correlation operator 52 may perform correlation operations bidirectionally. For example, as illustrated in FIG. 9, the correlation operator 52 may perform a correlation operation between the first and second attention features 53 and 54 based on the first attention feature 53, thereby generating the correlation feature 37-1, which may also be referred to as the first correlation feature 37-1. Here, the correlation operation performed based on the first attention feature 53 means a correlation operation performed between an individual pixel of the first attention feature 53 and the corresponding pixel region of the second attention feature 54. Then, the correlation operator 52 may perform a correlation operation between the first and second attention features 53 and 54 based on the second attention feature 54, thereby generating the correlation feature 37-2, which may also be referred to as the second correlation feature 37-2. That is, the correlation operator 52 may generate the second correlation feature 37-2 through a correlation operation between an individual pixel of the second attention feature 54 and the corresponding pixel region of the first attention feature 53. The second correlation feature 37-2 may be considered as a feature more associated with the second document image 35-2, which is input to the second decoder 34.

Referring back to FIG. 3 or 4, the first decoder 33 is a module that decodes, for example, the first correlation feature 37-1, to output or predict a segmentation map 38-1 (hereinafter, the first segmentation map 38-1) for the first document image 35-1. Here, the first segmentation map 38-1 may be understood as being a map representing information on areas in the first document image 35-1 that are identical to or different from the second document image 35-2.

For example, as illustrated in FIG. 4, the first decoder 33 may generate the first segmentation map 38-1 by decoding the correlation features (37-1 and 43-1) generated based on the features (36-1 and 41-1) from the first document image 35-1.

The first decoder 33 may be implemented or configured based on, for example, deconvolution layers, upsampling layers, fully-connected layers, etc., but the present disclosure is not limited thereto. The first decoder 33 may be implemented in any manner as long as it may properly produce and output the first segmentation map 38-1.

In some embodiments, as illustrated in FIG. 10, the first decoder 33 may be configured to include a second attention operator 101 and a segmentation predictor 102, and this will hereinafter be described with reference to FIGS. 10 and 11.

FIG. 10 is a schematic drawing for explaining the structure and operation of the first decoder 33. FIG. 10 illustrates an example where the largest scale feature 42-1 among the multi-scale features from the first document image 35-1 is input to the first decoder 33.

Referring to FIG. 10, the first decoder 33 may be configured to include the second attention operator 101 and the segmentation predictor 102.

The second attention operator 101 is a module that performs an attention operation (i.e., a cross-attention operation) between input correlation features. The second attention operator 101 may generate an attention feature 103 through an attention operation between the correlation feature 37-1 and the feature 42-1, and may also generate an attention feature 104 through an attention operation between the correlation feature 43-1 and the feature of another scale. The second attention operator 101 may perform attention operations bidirectionally (for more information, refer to the description of the first attention operator 101).

In some embodiments, referring to FIG. 11, the second attention operator 101 may be configured to consecutively perform two attention operations. That is, the second attention operator 101 may be configured to include a third attention module 111 and a fourth attention module 112. Specifically, the third attention module 111 of the second attention operator 101 may perform the first attention operation (or 1-th/primary attention operation) on the correlation feature 37-1 and the feature 42-1, thereby obtaining the first attention operation result 113. Here, the correlation feature 37-1 corresponds to the query Q, and the feature 42-1 corresponds to the key K and the value V. Then, the fourth attention module 112 of the second attention operator 101 may perform the second attention operation (or 2-th/secondary attention operation) on the correlation feature 37-1 and the first attention operation result 113, thereby generating the attention feature 103.

For more information on the second attention operator 102, refer back to the descriptions of the first attention operator 51 in FIGS. 5 through 7.

Referring back to FIG. 10, the segmentation predictor 102 is a module that predicts and outputs the first segmentation map 38-1 based on the attention feature 103 (or set of attention features). For example, the segmentation predictor 102 may aggregate the attention features (103, 104), analyze them, and predict the class (i.e., class label) for each pixel of the first document image 35-1, resulting in the creation of the first segmentation map 38-1.

The segmentation predictor 102 may be implemented or configured based on, for instance, deconvolution layers, upsampling layers, fully-connected layers, etc., but the present disclosure is not limited thereto. The segmentation predictor 102 may be implemented in any manner as long as it may properly produce and output the first segmentation map 38-1.

Referring back to FIG. 3 or 4, the second decoder 34 is a module that decodes, for example, the second correlation feature 37-2 to output or predict a segmentation map 38-2, which may also be referred to as the second segmentation map 38-2, for the second document image 35-2. Here, the second segmentation map 38-2 may be understood as being a map indicating information on areas in the second document image 35-2 that are identical to or different from the first document image 35-1.

For example, as illustrated in FIG. 4, the second decoder 34 may decode the correlation features (37-2 and 41-1) generated based on the features (36-2 and 41-2) from the second document image 35-2 to create the second segmentation map 38-2. For more information on the second decoder 34, refer to the description of the first decoder 33.

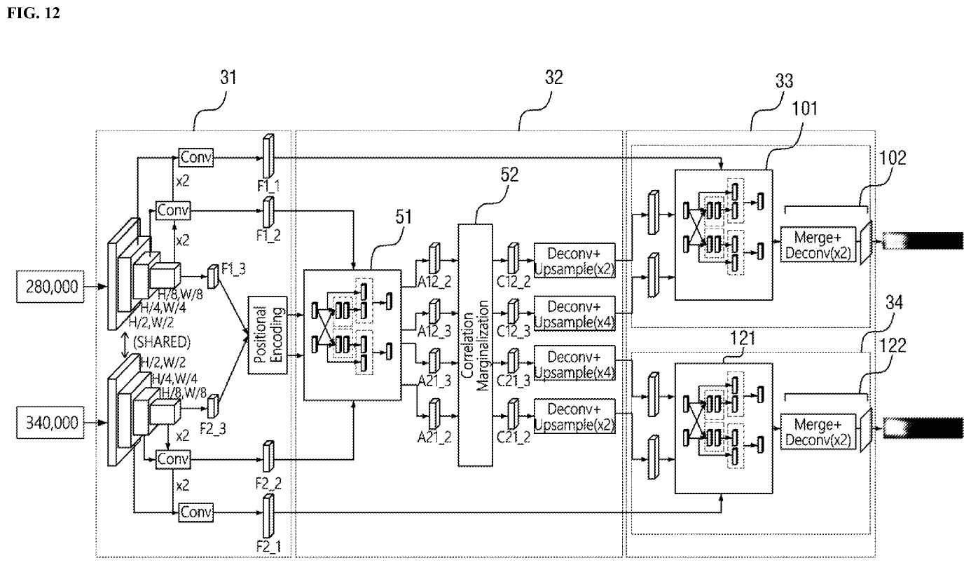

FIG. 12 illustrates an actual implementation of the deep learning model 11 according to some embodiments of the present disclosure.

Referring to FIG. 12, the deep learning model 11 may be configured to include a common encoder 31 and first and second decoders 33 and 34, which correspond to their respective document images. The second decoder 34 may be configured to have the same structure as the first decoder 33. That is, the second decoder 34, like the first decoder 33, may be configured to include an attention operator 121 (e.g., a third attention operator) and a segmentation predictor 122.

A positional encoding module as shown in FIG. 12 refers to a module that adds position information to input features so that the first attention operator 51 may distinguish between the input features. The concept and operating principles of the positional encoding module are already well known in the art to which the present disclosure pertains, and thus, detailed descriptions thereof will be omitted.

“Correlation” and “Marginalization” of FIG. 12 refer to the correlation operator 52.

FIG. 13 illustrates another actual implementation of the first attention operator 51 or the second attention operator 101. For example, as illustrated in FIG. 13, an attention module 131 on the left and an attention module 132 on the right may be understood as corresponding to the first and second attention modules 61 and 62, respectively. FIG. 13 illustrates an example where the result of an attention operation is configured to be reflected back into each input feature (e.g., input features are reflected again to “Conv_Block3” and a subsequent addition operation).

The structure and internal operations of the deep learning model 11 have been described so far with reference to FIGS. 3 through 13. Various methods that may be performed in the comparison system 10 will hereinafter be described.

For a better understanding, it is assumed that all steps/actions of methods that will hereinafter be described are performed by the comparison system 10. Thus, even if the subject of a particular step/action is not specifically mentioned, it may be understood as being performed by the comparison system 10. However, in reality, some steps of the methods that will hereinafter be described may be performed on other computing devices. For example, the training of the deep learning model 11 may be performed on a different computing device.

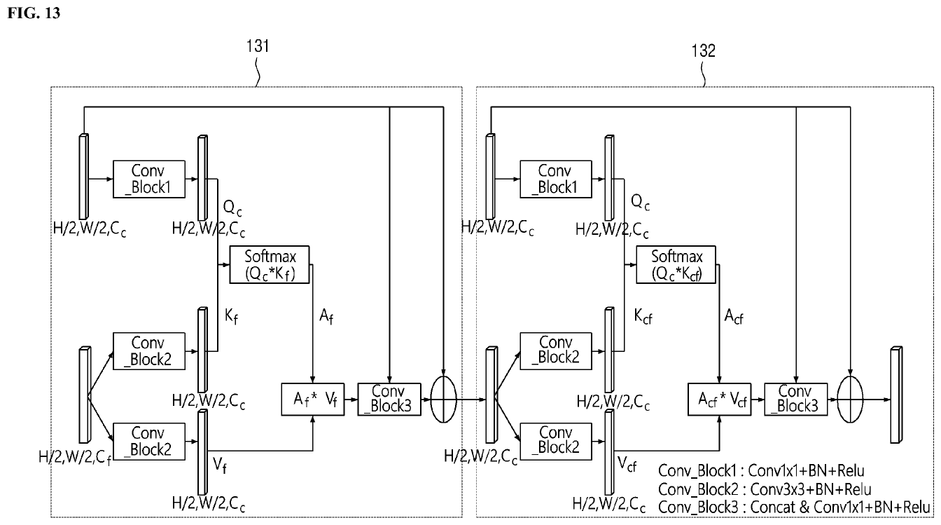

FIG. 14 is an example flowchart illustrating a document comparison method according to some embodiments of the present disclosure. The embodiment of FIG. 14 is merely example for achieving the purposes of the present disclosure, and some steps may be added to or omitted from the embodiment of FIG. 14, as necessary. FIG. 14 depicts steps commonly performed in both the training and inference procedures of the deep learning model 11.

Referring to FIG. 14, the document comparison method may begin with step S141, which involves acquiring images of first and second documents. Here, the first and second documents refer to two documents on which document comparison is to be performed.

A method to acquire the two document images in step S141 may vary.

For example, during the inference procedure of the deep learning model 11, the comparison system 10 may convert first and second documents, which are in the format of text, into image format to acquire first and second document images. Alternatively, the comparison system 10 may initially receive the first and second document images in the image format.

As another example, in the training procedure of the deep learning model 11, the comparison system 10 may generate various positive pairs (i.e., pairs of identical first and second document images) and/or negative pairs (i.e., pairs of different first and second document images) through a data augmentation technique. Specifically, the comparison system 10 may create a negative pair by making some changes to the content of the first document in the text format to create the second document and then converting the first and second documents into the image format. Alternatively, the comparison system 10 may create a positive pair by slightly changing the font of the first document in the text format to create the second document and then converting the first and second documents into the image format. Alternatively, the comparison system 10 may change the quality of the first document image (e.g., changing the document tilt or adding noise) to create the second document image, in which case, the first and second document images form a positive pair.

In some embodiments, the comparison system 10 may also automatically generate ground truth labels (e.g., a ground truth segmentation maps) based on the changed parts of the first document when generating negative pairs. Obviously, the comparison system 10 may also automatically generate ground truth labels (or correct answer labels) for positive pairs.

Additionally, the document images used in the training procedure may also be referred to as document image samples, etc.

In step S142, through the encoder 31 of the deep learning model 11, a first feature set may be extracted from the first document image, and a second feature set may be extracted from the second document image. Here, each of the first and second feature sets may include at least one feature.

For example, the comparison system 10 may extract the first and second feature sets, each consisting of multi-scale features, from the first and second document images, respectively, through the encoder 31 (for more information, refer to the descriptions in FIG. 4).

In step S143, a correlation feature set may be generated by analyzing the correlation between at least parts of the first and second feature sets. Here, the correlation feature set may include at least one correlation feature.

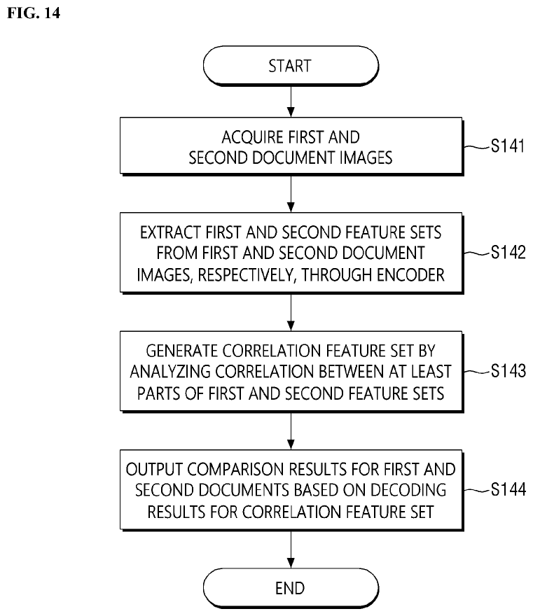

For example, as illustrated in FIG. 15, the comparison system 10 may perform attention operations bidirectionally on a first feature of the first feature set and a second feature of the second feature set that has the same scale as the first feature, thereby generating first and second attention features (S151) (for more information, refer to the descriptions in FIG. 6). Thereafter, the comparison system 10 may perform correlation operations on the first and second attention features, thereby generating one or more correlation features (S152). For example, the comparison system 10 may perform correlation operations bidirectionally on the first and second attention features, thereby generating first and second correlation features (for more information, refer to the descriptions in FIGS. 7 through 9).

Steps S151 and S152 may be repeatedly performed for features of other scales. However, in some embodiments, largest scale features among sets of multi-scale features may be excluded from correlation analysis. Then, the excluded features may be used in a decoding process to generate more sophisticated segmentation maps. Specifically, as depicted in FIG. 4, the excluded features may be input to the first and second decoders 33 and 34 of the deep learning model 11 through skip-connections.

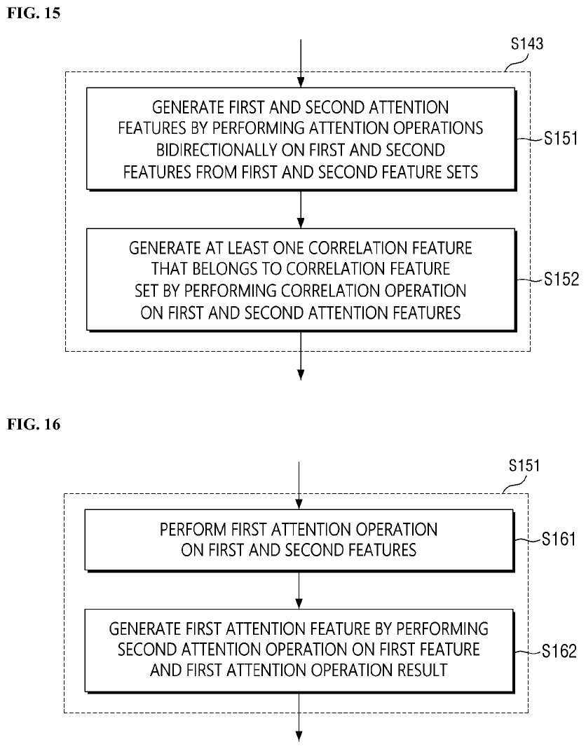

In some embodiments, the comparison system 10 may extract attention features through multiple consecutive attention operations (i.e., cross-attention operations). For example, as illustrated in FIG. 16, the comparison system 10 may perform the first attention operation (or 1-th/primary attention operation) on the first and second features (S161) and then generates the first attention feature by performing the second attention operation (or 2-th/secondary attention operation) on the first feature and the result of the first attention operation (S162). The comparison system 10 may generate the second attention feature in the same manner (for more information on steps S161 and S162, refer to the descriptions in FIG. 6).

Referring back to FIG. 14, in step S144, comparison results for the first and second documents may be output based on decoding results for the correlation feature set. Here, the comparison results may be, for example, segmentation maps output by the first decoder 33 of the deep learning model 11 or analysis results for the segmentation maps.

For example, the comparison system 10 may input the first correlation feature from the correlation feature set, which is associated with the first document image, into the first decoder 33 to generate the first segmentation map 38-1. Additionally, the comparison system 10 may input the second correlation feature from the correlation feature set, which is associated with the second document image, into the second decoder 34 to generate the second segmentation map 38-2 (for more information, refer to the descriptions in FIGS. 3 and 4).

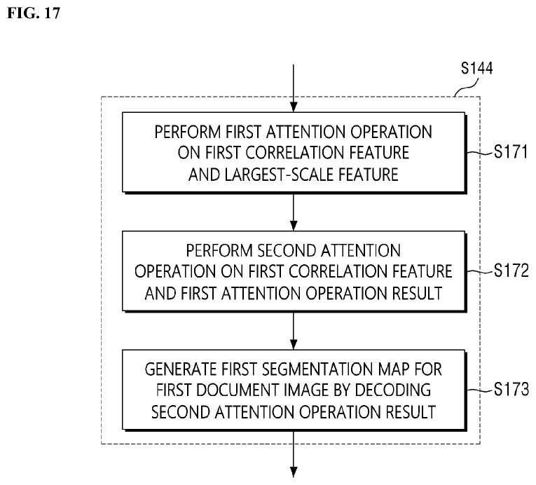

FIG. 17 is a detailed flowchart illustrating step S144, particularly, the step of generating the first segmentation map.

Referring to FIG. 17, the comparison system 10 may generate the first segmentation map based on the results of the decoding of the correlation feature set and the largest scale feature.

Specifically, the comparison system 10 may perform the first attention operation (or 1-th/primary attention operation) on the first correlation feature from the correlation feature set and the largest scale feature (S171) and then the second attention operation (or 2-th/primary attention operation) on the first correlation feature and the result of the first attention operation (S172). Then, the comparison system 10 may generate the first segmentation map for the first document image by decoding the result of the second attention operation (for more information, refer to the descriptions in FIGS. 10 and 11).

During the training procedure of the deep learning model 11, the comparison system 10 may further perform the steps of calculating losses using the comparison results for the first and second documents, and updating the parameters of the deep learning model 11 based on the calculated losses.

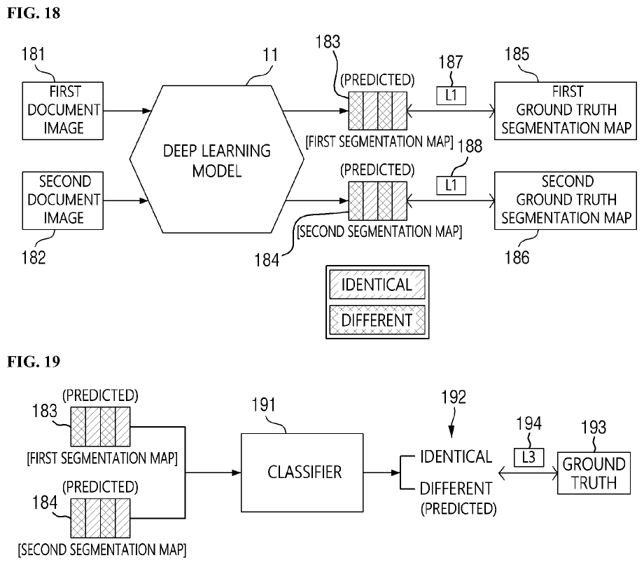

For example, as illustrated in FIG. 18, the comparison system 10 may calculate a loss 187 between a first segmentation map 183 and a first ground truth segmentation map 185 (i.e., the ground truth label for a first document image 181). Similarly, the comparison system 10 may calculate a loss 188 between the second segmentation map 184 and a second ground truth segmentation map 186 (i.e., the ground truth label for a second document image 182). Then, the comparison system 10 may update the parameters of the deep learning model 11 (e.g., the encoder 31, the first and second decoders 33 and 34, the first attention operator 51, etc.) based on the losses 187 and 188. For example, the loss 187 may be calculated based on a dice loss function (e.g., “1-Dice Score”) and a cross-entropy loss function, but the present disclosure is not limited thereto. The dice loss function and the cross-entropy loss function are already well known to the field to which the present disclosure pertains, and thus, detailed descriptions thereof will be omitted.

As another example, as illustrated in FIGS. 18 and 19, the comparison system 10 may update the parameters of the deep learning model 11 based on a loss (or cross-entropy loss) 194, which is calculated through a classifier 191. Specifically, the comparison system 10 may input the first and second segmentation maps 183 and 184 into the classifier 191 to obtain a prediction result 192 on whether the first and second document images 181 and 182 are identical. Then, the comparison system 10 may update the parameters of the classifier 191 and the deep learning model 11 based on the loss 194 between the prediction result 192 and a ground truth 193. The classifier 191 may be implemented in any manner. In some embodiments, the classifier 191 may be configured to further receive a max segmentation map in addition to the first and second segmentation maps 183 and 184. Here, the max segmentation map refer to a segmentation map created through a max operation (i.e., a maximum value operation) between the first and second segmentation maps 183 and 184.

As another example, the parameters of the deep learning model 11 may be updated based on various combinations of the aforementioned embodiments. For example, the comparison system 10 may calculate a total loss based on a weighted sum of the losses 187, 188, and 194 and update the parameters of the deep learning model 11 based on the calculated total loss.

The aforementioned step of updating the parameters of the deep learning model 11 may be performed repeatedly for various document images. As a result, the deep learning model 11 may be equipped with accurate document comparison capabilities.

The document comparison method according to some embodiments of the present disclosure has been described so far with reference to FIGS. 14 through 19. As described, the deep learning model 11 trained to compare documents at the image level may be used to compare the first and second documents. Accordingly, time and computing costs required for training in various languages may be reduced because image-level document comparison, unlike OCR-based document comparison, does not require language-specific training, and document comparison may be performed independently of the languages included in the documents (e.g., multilingual documents may be easily compared).

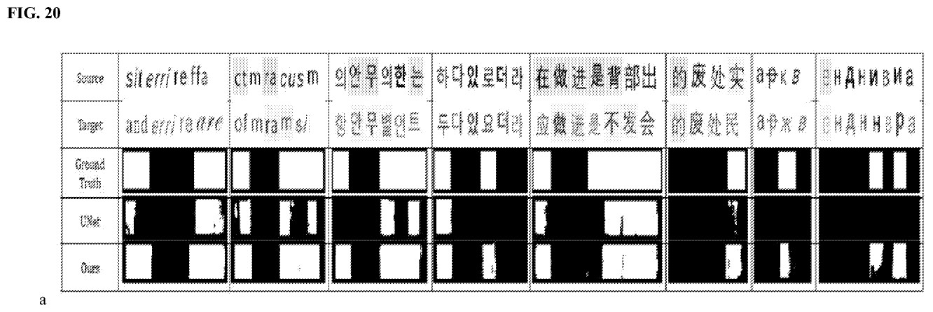

Moreover, the deep learning model 11 may be configured and trained to output comparison results (e.g., segmentation maps) for input document images using the results of feature-level correlation analysis. Thus, the influence of differences in fonts, quality (e.g., differences in document tilt), etc., on the accuracy of document comparison may be minimized (e.g., cases where minor font differences lead to the documents being considered different may be minimized), thereby enhancing the performance of the deep learning model (refer to the experimental results in FIG. 20). Furthermore, by performing a correlation operation between the channel vector of each individual pixel and the channel vector of the corresponding pixel region (i.e., the pixel region including neighboring pixels around the corresponding individual pixel), the performance of the deep learning model 11 may be further improved.

Experimental results for the document comparison method, referred to as the proposed method, according to some embodiments of the present disclosure will hereinafter be described.

The inventors of the present disclosure conducted experiments to evaluate the performance of the proposed method using the deep learning model with the structure illustrated in FIGS. 12 and 13. Specifically, the inventors trained the deep learning model using the losses illustrated in FIGS. 18 and 19, i.e., the losses 186, 187, and 194, and conducted experiments comparing segmentation maps of document images output by the trained deep learning model with the ground truth segmentation maps. Additionally, for performance comparison, the inventors also conducted experiments to output segmentation maps of document images using UNet, which is a representative model for semantic segmentation tasks. The structure and operating principles of UNet are already well known in the field to which the present disclosure pertains, and thus, detailed descriptions thereof will be omitted.

The experimental results are as shown in FIG. 20. In FIG. 20, “source” and “target” refer to pairs of document images being compared, “Ground Truth” refers to ground truth segmentation maps, and “Ours” refers to the proposed method.

Referring to FIG. 20, it may be observed that the segmentation maps according to the proposed method are almost identical to the ground truth segmentation maps, regardless of the language type. This demonstrates that accurate document comparison may be performed using the proposed method, even if the language included in each pair of document images changes.

Moreover, while the segmentation maps from the proposed method are almost identical to the ground truth segmentation maps, the segmentation maps produced by UNet display considerable differences from the ground truth segmentation maps. This suggests that performing correlation operations at the feature level may significantly enhance the accuracy of document comparison.

The experimental results for the document comparison method according to some embodiments of the present disclosure have been described so far with reference to FIG. 20. An example computing device 210 that may implement the comparison system 10 will hereinafter be described with reference to FIG. 21.

FIG. 21 is a hardware configuration view illustrating the computing device 210.

Referring to FIG. 21, the computing device 210 may include at least one processor 211, a bus 213, a communication interface 214, a memory 212, which loads a computer program 216 executed by the processor 211, and a storage 215 that stores the computer program 216. Even though FIG. 21 depicts only components related to the embodiments of the present disclosure, it is obvious to one of ordinary skill in the art to which the present disclosure pertains that the computing device 210 may further include other generic components, in addition to the components depicted in FIG. 21. Moreover, in some embodiments, the computing device 210 may be configured with some of the components depicted in FIG. 21 omitted. The components of the computing device 210 will hereinafter be described.

The processor 211 may control the overall operation of each of the components of the computing device 210. The processor 211 may be configured to include at least one of a central processing unit (CPU), a micro-processor unit (MPU), a micro-controller unit (MCU), a graphics processing unit (GPU), or any form of processor well-known in the field of the present disclosure. Additionally, the processor 211 may perform computations for at least one application or program to execute operations/methods according to some embodiments of the present disclosure. The computing device 210 may be equipped with one or more processors.

The memory 212 may store various data, commands, and/or information. The memory 212 may load the computer program 216 from the storage 215 to execute the operations/methods according to some embodiments of the present disclosure. The memory 212 may be implemented as a volatile memory such as a random-access memory (RAM), but the present disclosure is not limited thereto.

The bus 213 may provide communication functionality between the components of the computing device 210. The bus 213 may be implemented in various forms such as an address bus, a data bus, and a control bus.

The communication interface 214 may support wired or wireless Internet communication of the computing device 210. Additionally, the communication interface 214 may also support various other communication methods. To this end, the communication interface 214 may be configured to include a communication module well-known in the technical field of the present disclosure.

The storage 215 may non-transitorily store at least one computer program 216. The storage 215 may be configured to include a non-volatile memory such as a read-only memory (ROM), an erasable programmable ROM (EPROM), an electrically erasable programmable ROM (EEPROM), a flash memory, as well as a computer-readable recording medium in any form well-known in the technical field of the present disclosure, such as a hard disk or a removable disk.

The computer program 216, when loaded into the memory 212, may include one or more instructions that enable the processor 211 to perform the operations/methods according to some embodiments of the present disclosure. That is, by executing the loaded one or more instructions, the processor 211 may perform the operations/methods according to some embodiments of the present disclosure.

For example, the computer program 216 may include instructions for performing the operations of: acquiring first and second document images; extracting first and second feature sets from the first and second document images, respectively, through the encoder 31; generating a correlation feature set by analyzing the correlations between at least parts of the first and second feature sets; and outputting comparison results for the first and second document images based on decoding results for the correlation feature set.

As another example, the computer program 216 may include instructions to perform at least some of the steps/operations described above with reference to FIGS. 1 through 20.

In this example, the computing device 210 may implement the comparison system 10 according to some embodiments of the present disclosure.

Meanwhile, in some embodiments, the computing device 210 of FIG. 21 may refer to a virtual machine implemented based on cloud technology. For example, the computing device 210 may be a virtual machine operating on one or more physical servers included in a server farm. In this example, at least some of the processor 211, the memory 212, and the storage 215 may be virtual hardware, and the communication interface 214 may also be implemented as a virtualized networking element such as a virtual switch.

The computing device 210 that may implement the comparison system 10 according to some embodiments of the present disclosure has been described so far with reference to FIG. 21.

Various embodiments of the present disclosure and their effects have been mentioned thus far with reference to FIGS. 1 through 21.

According to some embodiments of the present disclosure, documents may be compared at an image level using a deep learning model trained for document comparison. In this case, the time and computing cost associated with training in various languages because document comparison at the image level, unlike OCR-based document comparison, does not require language-specific training. Also, language-independent (or non-dependent) document comparison may be conducted, and thus, multilingual documents may be easily compared.

Moreover, a deep learning model may be configured and trained to use the results of feature-level correlation analysis to output comparison results (e.g., segmentation maps) for input document images. In this case, the influence of font differences, quality differences (e.g., variations in the tilt of documents), etc., on the accuracy of document comparison may be minimized (e.g., cases where minor font differences lead to the documents being considered different may be minimized), thereby enhancing the performance of the deep learning model (refer to the experimental results in FIG. 20). Furthermore, when performing a correlation operation between a first feature (e.g., attention feature) extracted from a first document image and a second feature (e.g., attention feature) extracted from a second document image, the correlation operation may be performed between the first feature and the pixel region including the second feature and the neighboring pixels around the second feature). As a result, the performance of the deep learning model may be further improved.

Additionally, by configuring the deep learning model's correlation analyzer to perform correlation analysis using multi-scale features, accurate comparison may be achieved even between document images containing characters of various sizes.

Furthermore, by configuring the deep learning model's attention operator to perform consecutive attention operations, the performance of the deep learning model may be further enhanced.

Also, by configuring the deep learning model's decoder to further receive features of a largest scale (i.e., the lowest level of abstraction) among the multi-scale features, sophisticated segmentation maps for the input document images may be easily generated.

In addition, by configuring the deep learning model's correlation analyzer to perform operations in both directions, the performance of the deep learning model may be further improved. For example, through bidirectional operations, sophisticated segmentation maps for both the first and the second document images may be generated.

It should be noted that the effects of the present disclosure are not limited to those described above, and other effects of the present disclosure will be apparent from the following description.

The effects according to the technical idea of the present disclosure are not limited to those mentioned above, and other effects not mentioned may be clearly understood by one of ordinary skill in the related art from the description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for comparing documents performed by at least one processor, the method comprising:
acquiring a first document image and a second document image;
extracting a first feature set from the first document image and a second feature set from the second document image through an encoder;
generating a correlation feature set by analyzing a correlation between at least part of the first feature set and at least part of the second feature set; and
outputting a result of comparison between the first document image and the second document image based on a result of decoding the correlation feature set.

2. The method of claim 1, wherein the first feature set comprises a first feature and a second feature of a different scale from the first feature, and
the second feature set comprises a third feature of a same scale as the first feature and a fourth feature of a same scale as the second feature, and
wherein the generating the correlation feature set comprises:
generating a first correlation feature, which belongs to the correlation feature set, by analyzing a correlation between the first feature and the third feature; and
generating a second correlation feature, which belongs to the correlation feature set, by analyzing a correlation between the second feature and the fourth feature.

3. The method of claim 1, wherein the generating the correlation feature set comprises:
generating a first attention feature and a second attention feature by performing an attention operation on a first feature, which belong to the first feature set, and a second feature, which belong to the second feature set; and
generating one or more correlation features that belong to the correlation feature set by performing a correlation operation on the first attention feature and the second attention feature.

4. The method of claim 3, wherein the generating the first attention feature and the second attention feature comprises:
performing a first attention operation on the first feature and the second feature; and
generating the first attention feature by performing a second attention operation on the first feature and a result of the first attention operation.

5. The method of claim 4, wherein the first feature corresponds to a query, and the second feature corresponds to a key for the first attention operation, and
wherein the generating the first attention feature and the second attention feature further comprises:
performing a third attention operation on the first feature and the second feature, wherein the second feature corresponds to a query for the third attention operation and the first feature corresponds to a key for the third attention operation; and
generating the second attention feature by performing a fourth attention operation on the second feature and a result of the third attention operation.

6. The method of claim 3, wherein the first attention feature and the second attention feature are feature maps comprising a plurality of pixels, respectively, and
wherein the generating the one or more correlation features comprises:
determining a first pixel region in the second attention feature that corresponds to a first pixel in the first attention feature, wherein the first pixel region comprises a second pixel in the second attention feature that exists at a location corresponding to the first pixel and a neighboring pixel of the second pixel; and
generating a first correlation feature by performing a correlation operation on the first pixel and pixels included in the first pixel region.

7. The method of claim 6, wherein the first correlation feature is a feature map comprising a plurality of pixels,
wherein the generating the first correlation feature comprises:
calculating vector similarities between a channel vector for the first pixel and channel vectors for the pixels included in the first pixel region, and
wherein the calculated vector similarities form a channel vector for a third pixel in the first correlation feature that corresponds to the first pixel.

8. The method of claim 6, wherein the generating the one or more correlation features further comprises:
determining a second pixel region in the first attention feature that corresponds to a third pixel in the second attention feature, wherein the second pixel region comprises a fourth pixel in the first attention feature that exists at a location corresponding to the third pixel and a neighboring pixel of the fourth pixel; and
generating a second correlation feature by performing a correlation operation on the third pixel and pixels included in the second pixel region.

9. The method of claim 1, wherein the first feature set comprises multi-scale features,
a first feature of a largest scale among the multi-scale features is excluded from the analyzing the correlation, and
wherein the outputting the result of comparison comprises:
outputting the result of comparison based on a result of decoding the correlation feature set and the first feature.

10. The method of claim 9, wherein the outputting the result of comparison further comprises:
performing a first attention operation on the first feature and a first correlation feature that belongs to the correlation feature set;
performing a second attention operation on the first correlation feature and a result of the first attention operation; and
performing decoding based on a result of the second attention operation.

11. The method of claim 1, wherein the outputting the result of comparison comprises:
generating a segmentation map for the first document image by decoding at least part of the correlation feature set through a first decoder, wherein the segmentation map indicates information on areas in the first document image that are identical to and different from the second document image.

12. The method of claim 11, further comprising:
calculating a loss between the generated segmentation map and a ground truth segmentation map; and
updating parameters of the encoder and the first decoder based on the calculated loss,
wherein the loss is calculated using a dice loss function and a cross-entropy loss function.

13. The method of claim 11, further comprising:
acquiring a result of prediction of whether the first document image is identical to the second document image by inputting the generated segmentation map to a classifier; and
updating parameters of the encoder and the first decoder based on a loss between the result of prediction and a ground truth.

14. The method of claim 1, wherein the correlation feature set comprises a first correlation feature, which is generated based on a feature from the first feature set, and a second correlation feature, which is generated based on a feature from the second feature set, and
wherein the outputting the result of comparison comprises:
generating a first segmentation map for the first document image, which indicates information on areas in the first document image that are identical to and different from the second document image, by decoding the first correlation feature through a first decoder; and generating a second segmentation map for the second document image, which indicates information on areas in the second document image that are identical to and different from the first document image, by decoding the second correlation feature through a second decoder.

15. The method of claim 14, further comprising:
calculating a first loss between the first segmentation map and a first ground truth segmentation map for the first document image;
calculating a second loss between the second segmentation map and a second ground truth segmentation map for the second document image; and
updating parameters at least one of the encoder, the first decoder, and the second decoder based on the first loss and the second loss.

16. A system for comparing documents, the system comprising:
at least one processor; and
a memory configured to store a computer program that is executed by the at least one processor,
wherein the computer program comprises instructions to perform:
acquiring a first document image and a second document image;
extracting a first feature set from the first document image and a second feature set from the second document image through an encoder;
generating a correlation feature set by analyzing a correlation between at least part of the first feature set and at least part of the second feature set; and
outputting a result of comparison between the first document image and the second document image based on a result of decoding the correlation feature set.

17. A non-transitory computer-readable recording medium storing a computer program, which, when executed by at least one processor, causes the at least one processor to perform:
acquiring a first document image and a second document image;
extracting a first feature set from the first document image and a second feature set from the second document image through an encoder;
generating a correlation feature set by analyzing a correlation between at least part of the first feature set and at least part of the second feature set; and
outputting a result of comparison between the first document image and the second document image based on a result of decoding the correlation feature set.
